(19) United States
(12) Patent Application Publication
(10) Pub. No.: US 2025/0370114 A1
(43) Pub. Date: Dec. 4, 2025

(54) MULTI-DEVICE BISTATIC SENSING

(71) Applicant: Samsung Electronics Co., Ltd., Suwon-si (KR)

(72) Inventors: Jeongho Jeon, San Jose, CA (US); Pranav Madadi, Sunnyvale, CA (US); Daoud Burghal, San Diego, CA (US); Joonyoung Cho, Portland, OR (US); Jianzhong Zhang, Dallas, TX (US)

(21) Appl. No.: 19/299,183

(22) Filed: Aug. 13, 2025

Related U.S. Application Data
(63) Continuation of application No. 18/160,920, filed on Jan. 27, 2023.
(60) Provisional application No. 63/329,699, filed on Apr. 11, 2022.
(60) Provisional application No. 63/331,508, filed on Apr. 15, 2022.
(60) Provisional application No. 63/391,590, filed on Jul. 22, 2022.

(51) Int. Cl. G01S 13/00; G01S 7/00; G01S 13/04

(52) U.S. Cl. CPC G01S 13/003; G01S 7/006; G01S 13/04

(57) ABSTRACT

Joint configuration of cellular communication and bistatic object sensing involves transmitting, to a UE, a bistatic object sensing configuration. The bistatic object sensing configuration configures the UE to one of receive a sensing signal transmitted by a base station or transmit the sensing signal for reception by the base station. The bistatic object sensing configuration indicates sensing transmission power, waveform, and sensing resources and periodicity for the sensing signal, and may configure the UE to one of receive or transmit an object detection report.

### CROSS-REFERENCE TO RELATED APPLICATION AND CLAIM OF PRIORITY

This application is a continuation of U.S. patent application Ser. No. 18/160,920, filed on Jan. 27, 2023, which claims priority under 35 U.S.C. § 119(e) to U.S. Provisional Patent Application No. 63/329,699, filed on Apr. 11, 2022, U.S. Provisional Patent Application No. 63/331,508, filed on Apr. 15, 2022, and U.S. Provisional Patent Application No. 63/391,590, filed on Jul. 22, 2022. The content of the above-identified patent document(s) is incorporated herein by reference.

### TECHNICAL FIELD

The present disclosure relates generally to joint configuration of cellular communications and bistatic object sensing, and more specifically to configuring bistatic sensing using sensing signals transmitted by one of a UE and a base station and received by the other of the UE and the base station.

### BACKGROUND

To meet the demand for wireless data traffic having increased since deployment of 4G communication systems and to enable various vertical applications, 5G/NR communication systems have been developed and are currently being deployed. The 6G/5G/NR communication system is considered to be implemented in higher frequency (mmWave) bands, e.g., 28 giga-Hertz (GHz) or 60 GHz bands, so as to accomplish higher data rates or in lower frequency bands, such as 1-2 GHz, 3.5 GHz, or up to 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G and/or 6G systems and frequency bands associated therewith is for reference as certain embodiments of the present disclosure may be implemented in 5G systems. However, the present disclosure is not limited to 5G and/or 6G systems or the frequency bands associated therewith, and embodiments of the present disclosure may be utilized in connection with any frequency band. For example, aspects of the present disclosure may also be applied to deployment of 5G communication systems, as well as 6G or even later releases which may use terahertz (THz) bands.

### SUMMARY

Joint configuration of cellular communication and bistatic object sensing involves transmitting, to a UE, a bistatic object sensing configuration. The bistatic object sensing configuration configures the UE to one of receive a sensing signal transmitted by a base station or another UE, or transmit the sensing signal for reception by the base station or another UE. The bistatic object sensing configuration indicates sensing transmission power, waveform, and sensing resources and periodicity for the sensing signal, and may configure the UE to one of receive or transmit an object detection report.

In a first embodiment, a method performed by a user equipment (UE) for joint configuration of cellular communications and radar sensing includes receiving, from a base station, a configuration for performing bistatic object sensing by the UE using a sensing signal transmitted or received by one of the base station or another UE. The received bistatic object sensing configuration either configures the UE to transmit the sensing signal and indicates sensing signal waveform, sensing signal transmission power, sensing signal transmission resource, timing or periodicity for the sensing signal, whether directional beam sweeping is used, and whether any parameters are common for communications and object sensing, or configures the UE to receive the sensing signal and indicates include target sensing signal waveform, resource for receiving the sensing signal, timing for receiving the sensing signal, number of directional beams for reception of the sensing signal, and whether any parameters are common for communications and object sensing. The method also includes performing bistatic object sensing based on the received bistatic object sensing configuration.

In second embodiment, a user equipment (UE) configured for joint configuration of cellular communications and radar sensing includes a processor and a transceiver coupled to the processor. The transceiver is configured to receive, from a base station, a configuration for performing bistatic object sensing by the UE using a sensing signal transmitted or received by one of the base station or another UE. The received bistatic object sensing configuration either configures the UE to transmit the sensing signal and indicates sensing signal waveform, sensing signal transmission power, sensing signal transmission resource, timing or periodicity for the sensing signal, whether directional beam sweeping is used, and whether any parameters are common for communications and object sensing, or configures the UE to receive the sensing signal and indicates include target sensing signal waveform, resource for receiving the sensing signal, timing for receiving the sensing signal, number of directional beams for reception of the sensing signal, and whether any parameters are common for communications and object sensing. The UE is configured by the received bistatic object sensing configuration to perform bistatic object sensing.

In any of the preceding embodiments, the received bistatic object sensing configuration may configure the UE to transmit the sensing signal, in which case performing bistatic object sensing based on the received bistatic object sensing configuration comprises transmitting the sensing signal.

In any of the preceding embodiments, the received bistatic object sensing configuration may further indicate a destination of sensing reception reporting and a sensing reception reporting format, and the UE either receives an object detection report from the base station or another UE, or transmits an object detection report to the base station or another UE.

In the preceding embodiment, the sensing reception reporting format preferably includes at least one bit indicating whether a sensing signal correlator output or a sensing signal energy detector output exceeds a predetermined threshold.

In the preceding embodiment, the sensing reception reporting format preferably also includes an indication of whether a multipath profile is reported, If the multipath profile is reported, one or more of delay spread, number of tabs, tab gain, Doppler shift for the multipath profile, and whether multipath profile change is indicated. The sensing reception reporting format preferably also includes, if angle of arrival (AoA) information is configured, AoA of the received sensing signal and received sensing signal gain per different AoA. The sensing reception reporting format preferably also includes, if directional sensing is configured, at least one bit per beam. The sensing reception reporting format preferably also includes UE assistance information including the UE location, speed and trajectory.

In any of the preceding embodiments, the configuration for performing bistatic object sensing may be received as an indication of a set of allowed sensing configurations, and the UE may either transmit a sensing configuration request message for one of the allowed sensing configurations, or perform bistatic object sensing based on one of the allowed bistatic object sensing configurations.

In the preceding embodiment, UE assistance information for use in selection of the received bistatic object sensing configuration may be transmitted by the UE. The UE assistance information including sensing application type, UE location, UE mobility, and perceived channel environment.

In the preceding embodiment, the UE mobility may comprise an indication corresponding to one of pedestrian, vehicle or high-speed train, and the perceived channel environment may comprise one or more indication(s) of: urban macro cell (Uma), urban micro cell (Umi), indoor hotspot (InH), or rural; clutter/blockage presence, density, and/or severity; line of sight (LOS) or non-line of sight (NLOS); indoor or outdoor; in-car; or in-building.

In a third embodiment, a method performed by a base station (BS) includes transmitting, to a first user equipment (UE), a first configuration to transmit a sensing signal. The method also includes transmitting, to a second UE, a second configuration to receive a sensing signal. When the first configuration configures transmission of sensing object detection reports to the BS, the method further includes receiving, from at least one of the first UE or the second UE, a sensing report. The first configuration configures at least one of sensing signal waveform, transmission power, transmission resource, transmission timing, and directional beam sweeping. The second configuration configures at least one of target sensing signal waveform, resource, sensing signal timing, number of directional beams for reception, and reporting format.

In the third embodiment, the first configuration may configure the second UE to transmit the sensing report to at least one of the BS or the first UE.

In the third embodiment, the second configuration may configure the second UE to transmit the sensing report to and a sensing report format.

In the third embodiment, the the sensing report may include: at least one bit indicating whether a sensing signal correlator output or a sensing signal energy detector output exceeds a predetermined threshold, an indication of whether a multipath profile is reported and, if the multipath profile is reported, one or more of delay spread, number of tabs, tab gain, Doppler shift for the multipath profile, and changes to multipath profile is indicated, when angle of arrival (AoA) information is configured, AoA of the received sensing signal and received sensing signal gain per different AoA, when directional sensing is configured, the at least one bit per beam, and UE assistance information including the UE location, speed and trajectory.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. Likewise, the term “set” means one or more. Accordingly, a set of items can be a single item or a collection of two or more items.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an exemplary networked system utilizing reference signal temporal density configuration according to various embodiments of this disclosure;

FIG. 2 illustrates an exemplary base station (BS) utilizing reference signal temporal density configuration according to various embodiments of this disclosure;

FIG. 3 illustrates an exemplary electronic device for communicating in the networked computing system utilizing reference signal temporal density configuration according to various embodiments of this disclosure;

FIG. 4 illustrates a high level diagram of a monostatic radar according to various embodiments of this disclosure;

FIGS. 5A and 5B illustrate high level diagrams of a bistatic radar according to various embodiments of this disclosure;

FIG. 6 illustrates a high level diagram of a JCS implementation according to various embodiments of this disclosure;

FIG. 7 illustrates a high level diagram of a sensing procedure signal flow diagram according to various embodiments of this disclosure;

FIG. 8 illustrates a high level flowchart for UE operation of sensing configuration according to various embodiments of this disclosure;

FIG. 9 illustrates a high level flowchart for NW operation of sensing configuration according to various embodiments of this disclosure;

FIG. 10 illustrates an example timing diagram for monostatic sensing according to various embodiments of this disclosure;

FIG. 11 illustrates an example diagram for network controlled multi-UE bistatic sensing according to various embodiments of this disclosure;

FIG. 12 illustrates a high level diagram of a signal flow diagram for network controlled bistatic sensing according to various embodiments of this disclosure;

FIG. 13 illustrates a high level flowchart for a UE transmitting sensing signal in multi-UE bistatic sensing scenario according to various embodiments of this disclosure;

FIG. 14 illustrates a high level flowchart for a UE receiving sensing signal in multi-UE bistatic sensing scenario according to various embodiments of this disclosure;

FIG. 15 illustrates a high level flowchart for a NW in a multi-UE bistatic sensing scenario according to various embodiments of this disclosure;

FIG. 16 illustrates an example diagram for NW-UE bistatic sensing, with the UE as transmitter, according to various embodiments of this disclosure;

FIG. 17 illustrates a high level diagram of a signal flow for network-UE bistatic sensing, with the UE as transmitter, according to various embodiments of this disclosure;

FIG. 18 illustrates a high level flowchart for UE operation in a network-UE bistatic sensing scenario, with the UE as transmitter, according to various embodiments of this disclosure;

FIG. 19 illustrates a high level flowchart for network operation in a network-UE bistatic sensing scenario, with the UE as transmitter, according to various embodiments of this disclosure;

FIG. 20 illustrates an example diagram for NW-UE bistatic sensing, with the network as transmitter, according to various embodiments of this disclosure;

FIG. 21 illustrates a high level diagram of a signal flow for network-UE bistatic sensing, with the network as transmitter, according to various embodiments of this disclosure;

FIG. 22 illustrates a high level flowchart for UE operation in a network-UE bistatic sensing scenario, with the network as transmitter, according to various embodiments of this disclosure;

FIG. 23 illustrates a high level flowchart for network operation in a network-UE bistatic sensing scenario, with the network as transmitter, according to various embodiments of this disclosure;

FIG. 24 illustrates a high level flowchart for UE operation regarding sensing mode decision according to various embodiments of this disclosure;

FIG. 25 illustrates an example diagram for D2D bistatic sensing, in the case when the initiating UE is the sensing signal receiver, according to various embodiments of this disclosure;

FIG. 26 illustrates a high level diagram of a signal flow for D2D bistatic sensing, in the case when the initiating UE is the sensing signal receiver, according to various embodiments of this disclosure;

FIG. 27 illustrates a high level flowchart for UE operation of an initiating UE in a D2D bistatic sensing scenario according to various embodiments of this disclosure;

FIG. 28 illustrates a high level flowchart for UE operation of a responding UE in a D2D bistatic sensing scenario according to various embodiments of this disclosure;

FIG. 29 illustrates an example diagram for D2D bistatic sensing, in the case when the initiating UE is the sensing signal transmitter, according to various embodiments of this disclosure;

FIG. 30 illustrates a high level diagram of a signal flow for D2D bistatic sensing, in the case when the initiating UE is the sensing signal transmitter, according to various embodiments of this disclosure;

FIG. 31 illustrates a high level flowchart for UE operation of a responding UE in a D2D bistatic sensing scenario according to various embodiments of this disclosure; and

FIG. 32 illustrates a high level flowchart for UE operation of a responding UE in a D2D bistatic sensing scenario according to various embodiments of this disclosure.

### DETAILED DESCRIPTION

The figures included herein, and the various embodiments used to describe the principles of the present disclosure are by way of illustration only and should not be construed in any way to limit the scope of the disclosure. Further, those skilled in the art will understand that the principles of the present disclosure may be implemented in any suitably arranged wireless communication system.

### References

[1] 3GPP TS 38.211 Rel-16 v16.4.0, “NR; Physical channels and modulation,” December 2020.
[2] 3GPP TS 38.212 Rel-16 v16.4.0, “NR; Multiplexing and channel coding,” December 2020.
[3] 3GPP TS 38.213 Rel-16 v16.4.0, “NR; Physical layer procedures for control,” December 2020.
[4] 3GPP TS 38.214 Rel-16 v16.4.0, “NR; Physical layer procedures for data,” December 2020.
[5] 3GPP TS 38.321 Rel-16 v16.3.0, “NR; Medium Access Control (MAC) protocol specification,” December 2020.
[6] 3GPP TS 38.331 Rel-16 v16.3.0, “NR; Radio Resource Control (RRC) protocol specification,” December 2020.
[7] 3GPP TS 38.300 Rel-16 v16.4.0, “NR; NR and NG-RAN Overall Description; Stage 2,” December 2020.

The above-identified references are incorporated herein by reference.

### Abbreviations

3GPP Third generation partnership project
ACK Acknowledgement
AP Antenna port
BCCH Broadcast control channel
BCH Broadcast channel
BD Blind decoding
BFR Beam failure recovery
BI Back-off indicator
BW Bandwidth
BLER Block error ratio
BL/CE Bandwidth limited, coverage enhanced
BWP Bandwidth Part
CA Carrier aggregation
CE Contention based
CBG Code block group
CBRA Contention based random access
CBS PUR Contention based shared PUR
CCE Control Channel Element
CD-SSB Cell-defining SSB
CE Coverage enhancement
CFRA Contention free random access
CFS PUR Contention free shared PUR
CG Configured grant
CGI Cell global identifier
CI Cancellation indication
CORESET Control Resource Set
CP Cyclic prefix
C-RNTI Cell RNTI
CRB Common resource block
CR-ID Contention resolution identity
CRC Cyclic Redundancy Check
CSI Channel State Information
CSI-RS Channel State Information Reference Signal
CS-G-RNRI Configured scheduling group RNTI
CS-RNTI Configured scheduling RNTI
CSS Common search space
DAI Downlink assignment index
DCI Downlink Control Information
DFI Downlink Feedback Information
DL Downlink
DMRS Demodulation Reference Signal
DTE Downlink transmission entity
EIRP Effective isotropic radiated power
eMTC enhanced machine type communication

EPRE Energy per resource element
FDD Frequency Division Duplexing
FDM Frequency division multiplexing
FDRA Frequency domain resource allocation
FR1 Frequency range 1
FR2 Frequency range 2
gNB gNodeB
GPS Global positioning system
HARQ Hybrid automatic repeat request
HARQ-ACK Hybrid automatic repeat request acknowledgement
HARQ-NACK Hybrid automatic repeat request negative acknowledgement
HPN HARQ process number
ID Identity
IE Information element
IIoT Industrial internet of things
IoT Internet of Things
JCS Joint Communication and Sensing
KPI Key performance indicator
LBT Listen before talk
LNA Low-noise amplifier
LRR Link recovery request
LSB Least significant bit
LTE Long Term Evolution
MAC Medium access control
MAC-CE MAC control element
MCG Master cell group
MCS Modulation and coding scheme
MIB Master Information Block
MIMO Multiple input multiple output
MPE maximum permissible exposure
MTC Machine type communication
mMTC massive machine type communication
MSB Most significant bit
NACK Negative acknowledgment
NDI New data indicator
NPN Non-public network
NR New Radio
NR-L NR Light/NR Lite
NR-U NR unlicensed
NTN Non-terrestrial network
NW Network
OSI Other system information
PA Power amplifier
PI Preemption indication
PBCH Physical broadcast channel
PCell Primary cell
PRACH Physical Random Access Channel
PDCCH Physical Downlink Control Channel
PDSCH Physical Downlink Shared Channel
PUCCH Physical Uplink Control Channel
PUSCH Physical Uplink Shared Channel
PMI Precoder matrix indicator
P-MPR Power Management Maximum Power Reduction
PO PUSCH occasion
PSCell Primary secondary cell
PSS Primary synchronization signal
P-RNTI Paging RNTI
PRG Precoding resource block group
PRS Positioning reference signal
PTRS Phase tracking reference signal
PUR Pre-configured uplink resource
QCL Quasi co-located/Quasi co-location
RA Random access
RACH Random access channel
RAPID Random access preamble identity
RAR Random access response
RA-RNTI Random access RNTI
RAN Radio Access Network
RAT Radio access technology
RB Resource Block
RBG Resource Block group
RF Radio Frequency
RLF Radio link failure
RLM Radio link monitoring
RMSI Remaining minimum system information
RNTI Radio Network Temporary Identifier
RO RACH occasion
RRC Radio Resource Control
RS Reference Signal
RSRP Reference signal received power
RV Redundancy version
Rx Receive/Receiving
SAR Specific absorption rate
SCG Secondary cell group
SFI Slot format indication
SFN System frame number
SI System Information
SIC Successive Interference Cancellation
SI-RNTI System Information RNTI
SIB System Information Block
SINR Signal to Interference and Noise Ratio
SCS Sub-carrier spacing
SMPTx Simultaneous multi-panel transmission
SMPTRx Simultaneous multi-panel transmission and reception
SpCell Special cell
SPS Semi-persistent scheduling
SR Scheduling Request
SRI SRS resource indicator
SRS Sounding reference signal
SS Synchronization signal
SSB SS/PBCH block
SSS Secondary synchronization signal
STxMP Simultaneous transmission by multiple panels
STRxMP Simultaneous transmission and reception by multiple panels
TA Timing advance
TB Transport Block
TBS Transport Block size
TCI Transmission Configuration Indication
TC-RNTI Temporary cell RNTI
TDD Time Division Duplexing
TDM Time division multiplexing
TDRA Time domain resource allocation
TPC Transmit Power Control
TRP Total radiated power
Tx Transmit/Transmitting
UCI Uplink Control Information
UE User Equipment
UL Uplink
UL-SCH Uplink shared channel
URLLC Ultra reliable and low latency communication
UTE Uplink transmission entity
V2X Vehicle to anything
VoIP Voice over Internet Protocol (IP)
XR extended reality k

The present disclosure relates to beyond 5G or 6G communication system to be

provided for supporting one or more of: higher data rates, lower latency, higher reliability, improved coverage, and massive connectivity, and so on. Various embodiments apply to UEs operating with other RATs and/or standards, such as different releases/generations of 3GPP standards (including beyond 5G, 6G, and so on), IEEE standards (such as 802.11/15/16), and so forth.

This disclosure pertains joint communication and radar sensing, wherein a UE is able to perform downlink/uplink/sidelink communication and also perform radar sensing by “sensing”/detecting environmental objects and their physical characteristics such as location/range, velocity/speed, elevation, angle, and so on. Radar sensing is achieved by sending a suitable sounding waveform and receiving and analyzing reflections or echoes of the sounding waveform. Such radar sensing operation can be used for applications such as proximity sensing, liveness detection, gesture control, face recognition, room/environment sensing, motion/presence detection, depth sensing, and so on, for various UE form factors. For some larger UE form factors, such as (driver-less) vehicles, trains, drones and so on, radar sensing can be additionally used for speed/cruise control, lane/elevation change, rear/blind spot view, parking assistance, and so on. Such radar sensing operation can be performed in various frequency bands, including millimeter wave (mmWave)/FR2 bands. In addition, with terra-Hertz (THz) spectrum, ultra-high resolution sensing, such as sub-cm level resolution, and sensitive Doppler detection, such as micro-Doppler detection, can be achieved with very large bandwidth allocation, for example, on the order of several giga-Hertz (GHz) or more.

Current implementations can support individual operation of communication and sensing, wherein the UE is equipped with separate modules, in terms of baseband processing units and/or RF chain and antenna arrays, for communication procedures and radar procedures. The separate communication and sensing architectures require repetitive implementation that increases UE complexity. In addition, since the two modules are designed separately, there is little/no coordination between the modules, so time/frequency/sequence/spatial resources are not efficiently used by the two modules, which in some cases can even lead to (self-)interference between the two modules of a same UE. In addition, the radar sensing operation of the UE can be based on pure implementation based methods and without any unified standards support, which can cause (significant) inter-UE issues, or may not be fully compatible with cellular systems. Furthermore, separate design of the two modules makes it difficult to use measurement or information acquired by one module to assist the other module. For example, the communication module may be unaware of a potential beam blockage due to a nearby object, although the sensing module may have already detected the object.

The bistatic sensing and the detailed embodiments described in this disclosure have various applications. In one example, the bistatic sensing can be applied for object sensing involving multiple vehicles and/or transmit-receive points (TRPs) where one or multiple vehicles or TRPs transmit sensing radar signal and another one or multiple vehicles or TRPs receive sensing radar signal and perform object detection. In another example, the bistatic sensing can be applied for home monitoring in which one or multiple UEs or TRPs in a residential space transmit periodic sensing radar signal and another one or multiple UEs and TRPs receive sensing radar signal. The receiving UEs or TRPs can perform various home monitoring functions such as intruder detection and sleep pattern monitoring by analyzing multipath signal propagation profile. Benefits of supporting sensing in communication systems, i.e., joint communication and sensing, include the reuse of existing communication devices and infrastructures as well as spectrum for sensing.

There is a need to develop a unified standard for support of joint communication and sensing to reduce the UE implementation complexity and enable coexistence of the two modules. There is another need to ensure time/frequency/sequence/spatial resources are efficiently used across communication and sensing modules of a same UE, as well as among different UEs performing these two operations, to reduce/avoid (self-)interference. There is a further need to design the two operations in such a way to provide assistance to each other by exchanging measurement results and acquired information, so that both procedures can operate more robustly and effectively.

The present disclosure provides designs for the support of joint communication and radar sensing. In particular, this disclosure is regarding a framework to support multi-device bistatic sensing in a network controlled manner in wireless communication systems.

Embodiments of the disclosure for supporting joint communication and radar sensing in wireless communication systems are summarized in the following and are fully elaborated further below.
Method and apparatus for bistatic sensing in which a UE transmits sensing signal and one or multiple other UEs receives sensing signal while the network configures UEs for their sensing signal transmission and reception.
Method and apparatus for bistatic sensing in which a UE transmits sensing signal and the network receives sensing signal while the network configures the UE for sensing signal transmission.
Method and apparatus for bistatic sensing in which the network transmits sensing signal and a UE receives sensing signal while the network configures the UE for sensing signal reception.
Method and apparatus for broadcasting allowed sensing configurations.
Method and apparatus for constructing and sending object detection message.
Method and apparatus for sensing mode determination between monostatic and bistatic sensing, and the determination of the role of transmitter or receiver for the case of bistatic sensing.

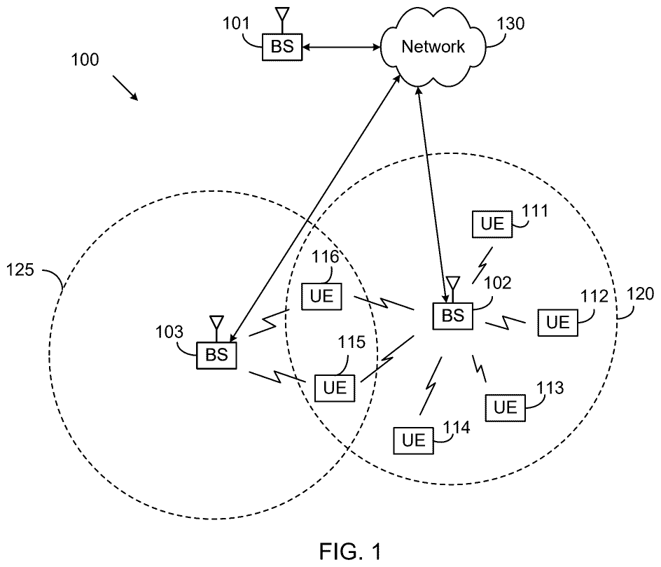

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an exemplary networked system utilizing reference signal temporal density configuration according to various embodiments of this disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

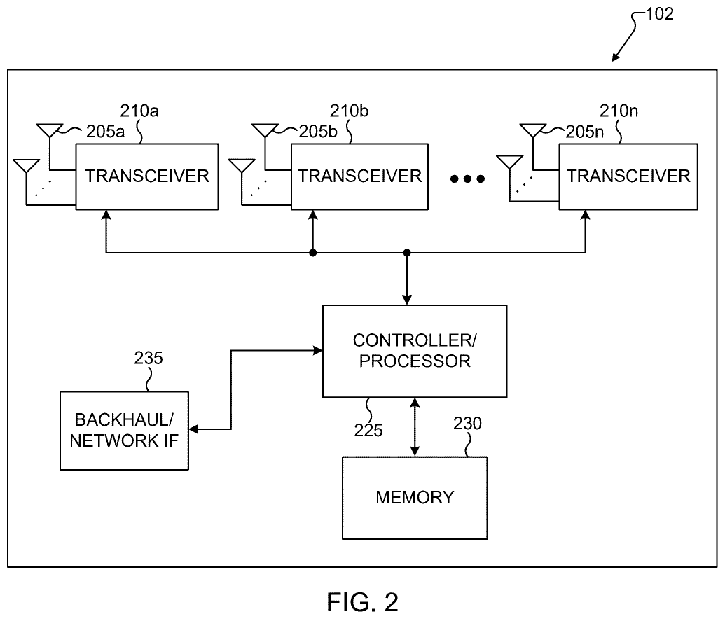

FIG. 2 illustrates an exemplary base station (BS) utilizing reference signal temporal density configuration according to various embodiments of this disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

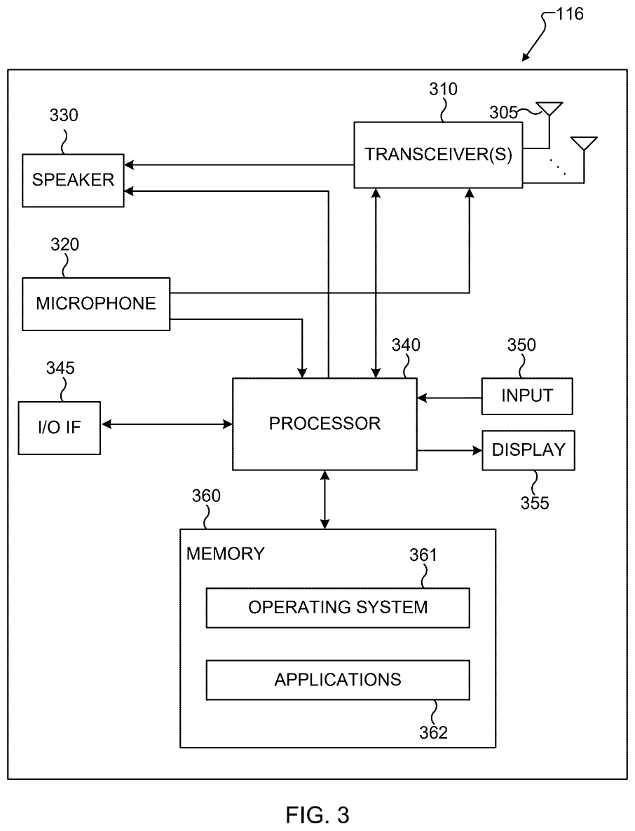

FIG. 3 illustrates an exemplary electronic device for communicating in the networked computing system utilizing reference signal temporal density configuration according to various embodiments of this disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

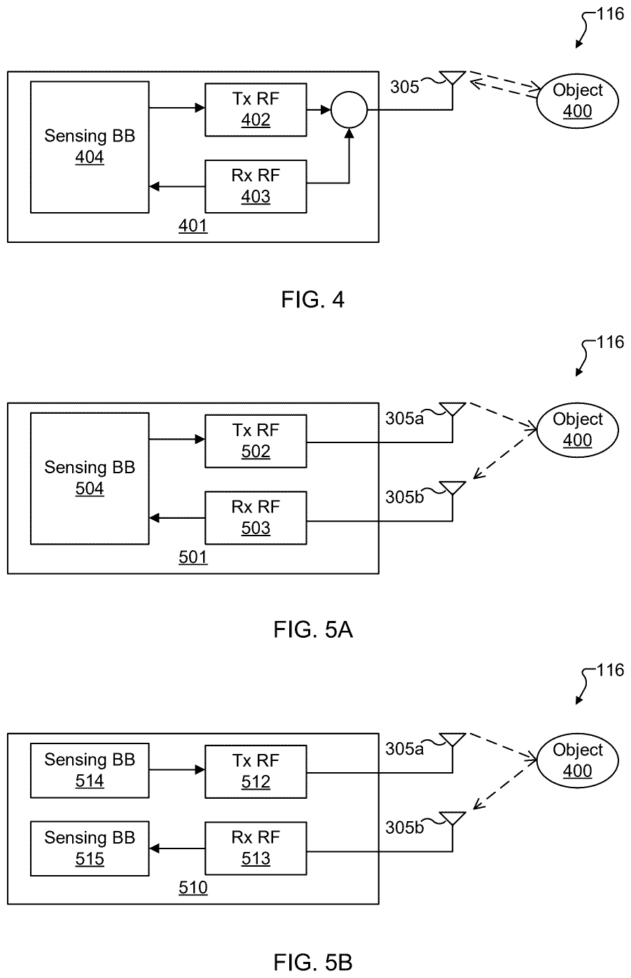

FIG. 4 illustrates a high level diagram of a monostatic radar according to various embodiments of this disclosure. The embodiment of FIG. 4 is for illustration only. Other embodiments of the system 401 could be used without departing from the scope of this disclosure.

FIG. 4 illustrates a monostatic radar system in which the transmission of radar waveform and the reception of reflected waveform alternates and performed within a device 116. Monostatic radar system 401 includes transmit RF processing 402 and receive RF processing 403 coupled to the same antenna 305, and respectively receiving output from and providing input to a single baseband (BB) processing circuit 404. Signals provided by transmit RF processing 402 are transmitted using the antenna 305, reflect off the object 400 and are received by antenna 305, and are filtered and otherwise pre-processed by receive RF processing 403 for use by sensing baseband processing circuit 404 in determining distance, velocity, acceleration, and/or direction of the object 400. Monostatic radar is suitable for short pulse sensing waveform. To avoid self-interference, the radio needs to turn around from transmission to reception before the reflected signal arrives.

FIGS. 5A and 5B illustrate high level diagrams of a bistatic radar according to various embodiments of this disclosure. The embodiments of FIGS. 5A-5B are for illustration only. Other embodiments of the systems 501, 510 could be used without departing from the scope of this disclosure.

FIGS. 5A and 5B illustrate a bistatic radar system in which the transmission of radar waveform and the reception of reflected waveform can be performed concurrently within a device 116. In each of FIGS. 5A and 5B, radar system 501, 510 includes respective transmit RF processing 502, 512 and respective receive RF processing 503, 513 coupled to different antenna 305a, 305b. In both FIG. 5A and FIG. 5B, signals provided by transmit RF processing 502, 512 are transmitted using one antenna 305a, reflect off the object 400 and are received by another antenna 305b, and are filtered and otherwise pre-processed by receive RF processing 503, 513. However, transmit RF processing 502 and receive RF processing 503 in FIG. 5A still respectively receive output from and provide input to a single baseband processing circuit 504. By contrast, transmit RF processing 512 receives output from one baseband processing circuit 514 in FIG. 5B, and receive RF processing 513 provides input to a separate baseband processing circuit 515.

Bistatic radar is suitable for continuous transmission of sensing waveform. Both transmission and reception processing modules can be placed within a device as shown in FIG. 5A. In this case, a separation between transmission and reception antennas is desired. FIG. 5B illustrates bistatic radar system where transmission and reception processing modules are placed in different devices. A separation between transmission and reception antennas is naturally achieved.

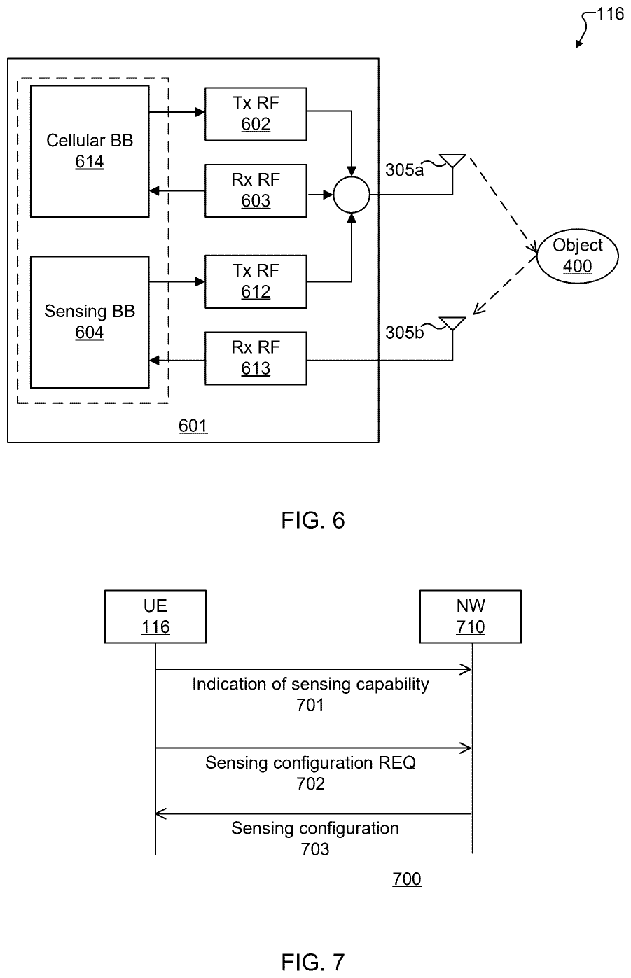

FIG. 6 illustrates a high level diagram of a JCS implementation according to various embodiments of this disclosure. The embodiment of FIG. 6 is for illustration only. Other embodiments of the system 601 could be used without departing from the scope of this disclosure.

FIG. 6 illustrates a possible JCS UE implementation for UEs having cellular communication modules. JCS system 601 includes transmit RF processing 602 and receive RF processing 603 coupled to one antenna 305a, and respectively receiving output from and providing input to a cellular baseband processing circuit 614. JCS system 601 also includes transmit RF processing 612 coupled to the first antenna 305a, and receive RF processing 603 coupled to a second antenna 305b. Transmit RF processing 612 and receive RF processing 603 respectively receive output from and provide input to a single sensing baseband processing circuit 604.

The cellular baseband processing circuit 614 and the sensing baseband processing circuit 604 may be discrete modules communicating with each other, or may be (as depicted) logically separate but integrated into a single module. In this example, the transmission of sensing waveform and the reception of reflected sensing waveform can be concurrent while transmission/reception for communication are switched off, enabling bistatic radar operation. Also, concurrent transmission for communication and reception for sensing waveform are possible. In that case, the sensing could be monostatic (the UE both transmits and receives sensing waveforms) or bistatic (another UE or device transmits the sensing waveform). Concurrent reception for communication and reception for sensing are also possible. SIC may be applied to remove the interference from sensing signal for the reception of communication signal or vice versa.

FIG. 7 illustrates a high level diagram of a sensing procedure signal flow diagram according to various embodiments of this disclosure. The embodiment of FIG. 7 is for illustration only. Other embodiments of signaling could be used without departing from the scope of this disclosure.

FIG. 7 is an example procedure for UE 116 and NW 710 (e.g., BS 102) to exchange messages for sensing configuration. In the first step 701, a UE 116 sends UE Capability Information (e.g., RRC message) to NW 710, informing the NW 710 of the UE's JCS capability including hardware (HW) capability, SIC capability, etc. In the second step 702, the UE 116 sends a sensing configuration request message including sensing application type, range, and sensing periodicity, etc. In the third step 703, the NW 710 configures sensing operations to UE 116 including waveform, resource, sensing transmission power, periodicity, etc.

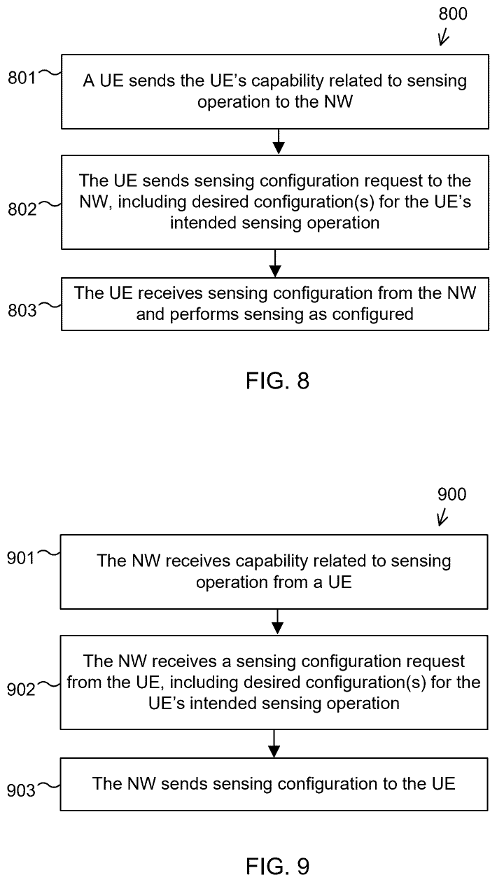

FIG. 8 illustrates a high level flowchart for UE operation of sensing configuration according to various embodiments of this disclosure. The embodiment of FIG. 8 is for illustration only. Other embodiments of the process 800 could be used without departing from the scope of this disclosure.

FIG. 8 is an example of a method 800 for sensing configuration from a UE perspective consistent with FIG. 7. At step 801, the UE sends the UE's capability (e.g., in an RRC message) related to sensing operations to the NW, informing the NW of the UE's JCS capability including hardware capability, SIC capability, etc. At step 802, the UE sends a sensing configuration request message including desired configuration(s) (sensing application type, range, and sensing periodicity, etc.). At step 803, the UE receives sensing configurations from the NW, and then performs sensing as configured.

FIG. 9 illustrates a high level flowchart for NW operation of sensing configuration according to various embodiments of this disclosure. The embodiment of FIG. 9 is for illustration only. Other embodiments of the process 900 could be used without departing from the scope of this disclosure.

FIG. 9 is an example of a method 900 for sensing configuration from a NW perspective, consistent with FIG. 7. At step 901, the NW receives the UE's capability (e.g., in an RRC message) related to sensing operations. At step 902, the NW receives a sensing configuration request message including desired configuration(s) (sensing application type, range, and sensing periodicity, etc.) for the UE's intended sensing operation. At step 903, the NW sends sensing configurations from the NW, and then performs sensing as configured.

In one embodiment, the UE can send its sensing capability to NW. TABLE 1 is an example list of possible information elements (IEs) for UE sensing capability indication to NW:

TABLE 1
Possible IEs for UE sensing capability indication msg

| | |
|---|---|
| BB coordination | Coordination between cellular and sensing modem |
| Sensing power class | Max Tx power for sensing |
| Sensing BW, | Max supported sensing BW; list of supported |
| supported bands, in- | bands for sensing; indication on whether |
| band sensing | in-band sensing is supported or not |
| capability, etc. | |
| RF/Antenna | Shared or separate between cellular and sensing |
| | Shared or separate between sensing Tx and |
| | sensing Rx (monostatic vs. bistatic) |
| Self-interference | Cancellation of cellular Tx signal from sensing Rx |
| cancellation (full- | Cancellation of sensing Tx signal from cellular Rx |
| duplex capability) | |
| SIC | SIC capability for simultaneous reception of |
| | cellular and sensing signals |
| Waveform | Supported types of sensing waveform |

In one example, the UE can indicate the UE's baseband coordination capability between cellular and sensing modems. Possible indication of values could include {tight coordination, loose coordination, no coordination} as an example. Tight coordination may indicate that the cellular baseband has a full control over sensing baseband or sensing capability is implemented as a function of cellular baseband within an integrated chipset. With tight coordination, a UE can be signaled on parameters related to sensing transmission and/or reception via physical channels and procedures defined for communication system. Furthermore, the UE's communication function can control time/frequency resources and other parameters for sensing transmission and/or reception. The UE may also perform interference cancellation between communication and sensing. Loose coordination may indicate that the cellular baseband and sensing baseband can communication on related parameters but one does not have a control over the other. With loose coordination, a UE's communication function can receive information related to time/frequency resources and other parameters related to sensing transmission and/or reception from sensing function. The UE's communication and sensing functions can share information related to the severity of interference from each other and the time/frequency resources affected by the interference. However, the decision on the sensing transmission/reception and interference avoidance is up to sensing function and may not be instructed by communication function. No coordination may indicate that the two baseband functions cannot communicate with each other.

In another example, the UE can indicate the UE's sensing power class to the NW. As an example, the UE can indicate that the UE's sensing power class is the same with the UE's power class for communication or a specific power value, e.g., in decibel-milliwatts (dBm), to the NW, if different.

In yet another example, the UE can indicate the UE's supported sensing bandwidth, e.g., in mega-Hertz (MHz) or giga-Hertz (GHz), so that the NW does not configure a UE for sensing bandwidth exceeding the UE's capability. The UE can also indicate the list of bands that the UE supports for sensing operation. It can be indicated, for instance, in terms of NR band identifier (ID). The UE can also indicate whether in-band sensing can be supported, i.e., operation within a band configured for communication. If in-band sensing is not supported, then by default, the NW can assume that only out-of-band sensing can be supported by the UE.

In yet another example, the UE can indicate whether RF/antennas are shared or separate between cellular and sensing functions. The UE can also indicate whether RF/antennas are shared or separate between sensing transmission and reception. Based on this information, the NW can configure a correct mode of sensing operation, e.g., monostatic or bistatic, and resources for the UE.

In yet another example, the UE can indicate whether the UE has self-interference cancellation capability, e.g., cancellation of cellular transmission signal from sensing reception signal or cancellation of sensing transmission signal from cellular reception signal, etc. The UE can also indicate successive interference cancellation capability between a signal received for communication and a signal received for sensing. The UE can also indicate supported types of sensing waveforms as a part of UE capability indication.

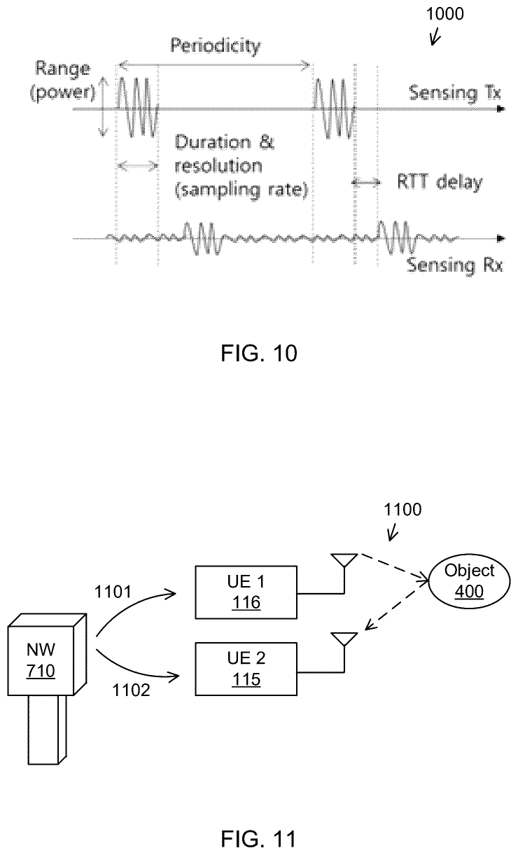

FIG. 10 illustrates an example timing diagram for monostatic sensing according to various embodiments of this disclosure. The embodiment of FIG. 10 is for illustration only. Other embodiments of the timing 1000 could be used without departing from the scope of this disclosure.

FIG. 10 is an example sensing timing diagram for monostatic sensing, i.e., transmission of sensing waveform and the reception of reflected signal occur one at a time due to shared RF/antennas. In this case, the sensing transmission signal duration Tsensing Tx should be less than or equal to TRIT-TT_Turnaround, where TRIT is the expected round-trip-time for sensing transmission signal bounce-back considering target sensing application and range and TTurnaround is sensing RF transmission-to-reception turnaround time. If bistatic sensing is supported by UE, no such restriction is required.

In one embodiment, UE sends sensing configuration request message including sensing application type, range, and sensing periodicity, etc. Table. 2 is an example list of possible IEs for

UE sensing configuration request message to NW:

TABLE 2
Possible IE for UE sensing configuration request msg

| | |
|---|---|
| Application type | Automotive, face/gesture recognition, etc. |
| Range | Target sensing range, e.g., short/mid/long range |
| | sensing |
| Periodicity | Continuous or periodic sensing w/interval |
| Resolution | Required resolution |
| Directional sensing | Beam sweeping for directional sensing, number |
| | of beams, antenna/beamforming gain, 3-dB beam |
| | width |
| Sensing direction | Time duration of sensing Tx signal and reception |
| | duration |

In one example, the UE can indicate the UE's sensing application type, such as automotive, face/gesture recognition, etc., as the sensing resource configuration by NW may depend on the requested sensing application type. In another embodiment, the sensing application type may not be directly indicated to the NW but may be indirectly indicated via attributes of required sensing resource configuration.

In another example, the UE can indicate the desired range of sensing operation. As an example, long range sensing may be requested for automotive application or similarly short range sensing may be requested for face/gesture recognition application. The requested range values can be {short, mid, long} with predefined range values for each element. The requested range values can be in terms of meters. The configured sensing transmission power level by NW may depend on this indication.

In yet another example, the UE can indicate the desired periodicity of the sensing, i.e., continuous or periodic sensing with a certain interval. The configured time-domain sensing resource by NW may depend on this indication.

In yet another example, the UE can indicate the desired resolution of the sensing, i.e., fine granularity for sensing. The configured sensing bandwidth by NW may depend on this indication.

In yet another example, the UE can indicate whether directional sensing is requested. In this case, the UE can indicate the desired beamforming gain, 3 decibel (dB) beam width, and the number of beams for sweeping. The UE can obtain object sensing results towards certain directions which can enable various use cases requiring directional sensing information.

In yet another example, the UE can indicate time duration of sensing transmission signal and reception duration. In the case of bistatic sensing, the transmission and reception can be continuous. In the case of monostatic sensing, the transmission duration can be dependent on sensing application type and/or target sensing range, etc.

In another embodiment, the UE can indicate an index from a set of predefined sensing modes (e.g., TABLE 3 below). Each mode is associated with attributes that can support a certain use case including transmission power, bandwidth, range, periodicity, resolution, directional sensing, sensing duration, etc.

TABLE 3
Example of predefined sensing mode

| Mode | Tx Power | BW | (Intended use case) |
|---|---|---|---|
| 1 | 20 dBm | 10 MHz | Automotive |
| 2 | −1 dBm | 100 MHz | Face recognition |
| 3 | 0 dBm | 40 MHz | Gesture recognition |
| 4 | 10 dBm | 20 MHz | Indoor presence detection |
| . . . | . . . | . . . | . . . |

In one embodiment, the NW configures a UE with sensing resources and attributes and the UE performs sensing according to the configuration. TABLE 4 is an example list of possible IEs for NW sensing configuration message:

TABLE 4
Possible IE for NW sensing configuration msg

| | |
|---|---|
| Max Tx power | Max sensing Tx power, i.e., P_{CMAX} |
| Target reception | For sensing Tx power control based on the pathloss |
| power | of the bounced back sensing Tx signal |
| Waveform | Sensing Tx waveform |
| Periodicity | Sensing periodicity interval |
| Sensing duration | Sensing Tx time duration and Rx time duration |
| Directional sensing | Allowed number of beams for sensing sweeping, |
| | allowed beamforming/antenna gain, 3-dB beam |
| | width, etc. |
| Resource | Sensing time/frequency resource configuration |
| | including signal BW and carrier frequency |

The IEs may include maximum transmission power for sensing waveform transmission, target reception power of the reflected sensing waveform for power control, sensing waveform and transmission periodicity, sensing duration, attributes for directional sensing including allowed number of beams and beam width, and sensing resource in time, frequency, and spatial domain, etc.

In the above-described embodiments, a UE first indicates the UE's sensing capability related information, followed by sensing resource configuration request and configuration by the NW for the UE to perform sensing functions. Alternatively, in another embodiment, the NW can broadcast a set of allowed sensing configurations. The broadcast information can include any combination of IEs disclosed in TABLES 1, 2, and 4 or by signaling a set of indices from a predefined configuration table as exemplified in TABLE 3. Such a broadcast message can be sent over MIB, SIB, or any cell-specific messages. The BS located in a different location can indicate different set of allowed sensing configurations. Upon receiving such broadcast message, the UE can send a sensing configuration request message to the NW within the set of allowed sensing configurations. Alternatively, in another embodiment, the UE can initiate sensing operations within the allowed set of configurations without further communicating with the NW for sending sensing request message and receiving the configuration message.

FIG. 11 illustrates an example diagram for network controlled multi-UE bistatic sensing according to various embodiments of this disclosure. The embodiment of FIG. 11 is for illustration only. Other embodiments of the system 1100 could be used without departing from the scope of this disclosure.

In one embodiment, the network controls multi-UE bistatic sensing in which a UE transmits sensing signal and another UE receives sensing signal. FIG. 11 is an example 1100 of network controlled multi-UE bistatic sensing. NW 710 sends configuration information 1101 to UE 1 116 and configuration information 1102 to UE 2 115. UE 1 116 transmits a sensing waveform in the direction of object 400, and UE 2 115 receives reflections of those waveforms off the object 400. Although the figure is illustrated for a two-UE scenario, there can be one or multiple UEs configured for sensing signal transmission and one or multiple UEs configured for sensing signal reception (in addition to the UE configured for sensing signal transmission).

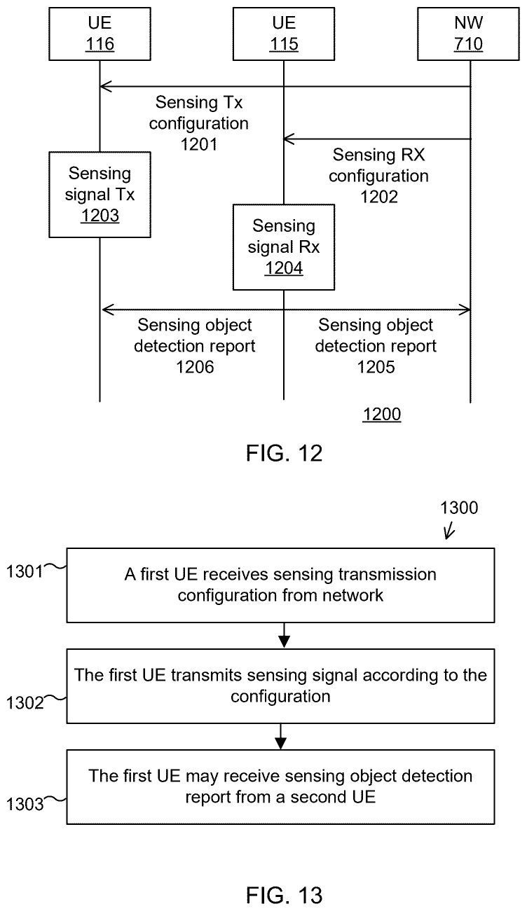

FIG. 12 illustrates a high level diagram of a signal flow for network controlled bistatic sensing according to various embodiments of this disclosure. The embodiment of FIG. 12 is for illustration only. Other embodiments of the system 1200 could be used without departing from the scope of this disclosure. FIG. 12 may be performed within the system 1100 depicted in FIG. 11.

FIG. 12 is an example procedure for network controlled bistatic sensing involving two UEs 115, 116 and the network 710. In step 1201, the network 710 configures the first UE 116 with sensing transmission. Sensing transmission configuration 1101 can include sensing signal waveform, transmission power, transmission resource, timing, directional beam sweeping, etc., including but not limited to those described in TABLE 4. In step 1202, the network 710 configures the second UE 115 with sensing reception. Sensing reception configuration 1102 can include target sensing signal waveform, resource, timing, and number of directional beams for reception, reporting format, etc., including but not limited to those described in TABLE 4. In step 1203, the first UE 116 transmits sensing signal according to the configuration. In step 1204, the second UE 115 receives sensing signal according to the configuration. After receiving the sensing signal, the second UE performs sensing object detection (not shown). Sensing object detection report(s) 1205, 1206 can be sent to the NW 710 and/or to the UE 116. The report(s) may not be sent if the UE 115 is the end consumer of the information. In another example, the UE 115 may send information regarding the received sensing signal instead of sensing object detection report 1205, 1206. Details on the destination of sensing reception feedback and the feedback format can be configured as a part of step 1202.

FIG. 13 illustrates a high level flowchart for a UE transmitting sensing signal in a multi-UE bistatic sensing scenario according to various embodiments of this disclosure. The embodiment of FIG. 13 is for illustration only. Other embodiments of the process 1300 could be used without departing from the scope of this disclosure.

FIG. 13 is an example of a method 1300 for network controlled multi-UE bistatic sensing from a perspective of UE transmitting sensing signal. In step 1301, a first UE receives a sensing transmission configuration from the network. In step 1302, the first UE transmits sensing signal(s) according to the configuration. In step 1303, the first UE may receive a sensing object detection report from a second UE, depending upon the configuration.

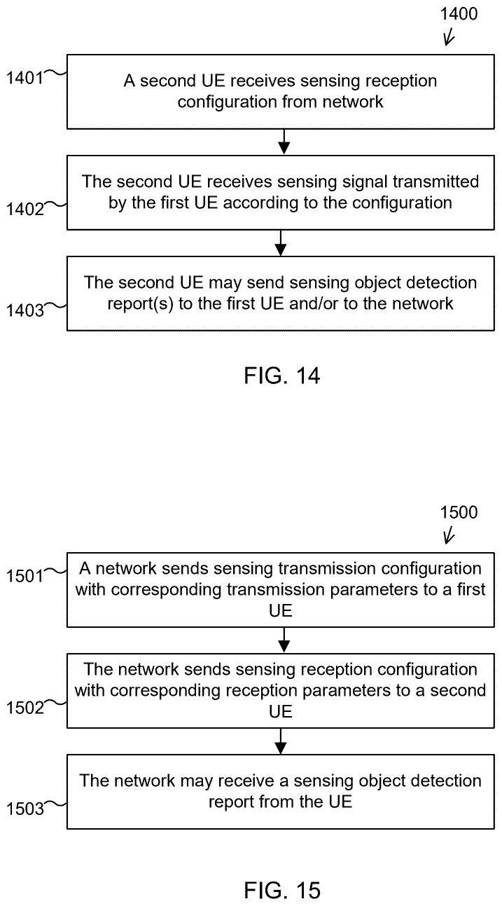

FIG. 14 illustrates a high level flowchart for a UE receiving sensing signal in multi-UE bistatic sensing scenario according to various embodiments of this disclosure. The embodiment of FIG. 14 is for illustration only. Other embodiments of the process 1400 could be used without departing from the scope of this disclosure.

FIG. 14 is an example of a method 1400 for network controlled multi-UE bistatic sensing from a perspective of UE receiving a sensing signal. In step 1401, a second UE receives a sensing reception configuration from the network. In step 1402, the second UE receives sensing signal(s) according to the configuration. In step 1403, the second UE may send sensing object detection report(s) from to the first UE and/or to the network, depending upon the configuration.

FIG. 15 illustrates a high level flowchart for a NW in a multi-UE bistatic sensing scenario according to various embodiments of this disclosure. The embodiment of FIG. 15 is for illustration only. Other embodiments of the process 1500 could be used without departing from the scope of this disclosure.

FIG. 15 is an example of a method 1500 for network controlled multi-UE bistatic sensing from network perspective. In step 1501, A network sends sensing transmission configuration with corresponding transmission parameters to a first UE. In step 1502, the network sends sensing reception configuration with corresponding reception parameters to a second UE. In step 1503, the network may receive a sensing object detection report from the UE.

The UE transmitting sensing signal(s) will be configured by the NW on the transmission related parameters including but not limited to those exemplified in TABLE 4. For instance, the transmitting UE will be configured with a sensing signal, including waveform and sequence, maximum transmission power and any power control related parameters, time/frequency resource for transmission, and beam sweeping related parameters (if directional sensing is configured). The UE receives these configurations through configuration mechanism supported in the communication system, e.g., higher layer signaling such as RRC messaging, and the set of parameters for sensing transmission and the set of parameters for communication can be different. If any parameters are common for sensing and communication, it can be indicated by network as well.

The UE receiving sensing signal will be configured by the NW on the reception related parameters including but not limited to those exemplified in TABLE 4. For instance, the receiving UE will be configured with the type of sensing signal, e.g., waveform/sequence etc., transmitted so that it can detect the signal. Also, in accordance with the time/frequency resource configured for the transmission, the receiving UE will be configured with the time/frequency resource for reception such that the UE can know of when and where to expect the reception. As the signal propagation will go through multiple different paths and will get delayed, a certain time instance/offset and a time window for reception can be configured to the UE. The time offset can be set to accommodate the propagation delay and the duration of the time window can be set to be sufficient to cover multi-path delay spread.

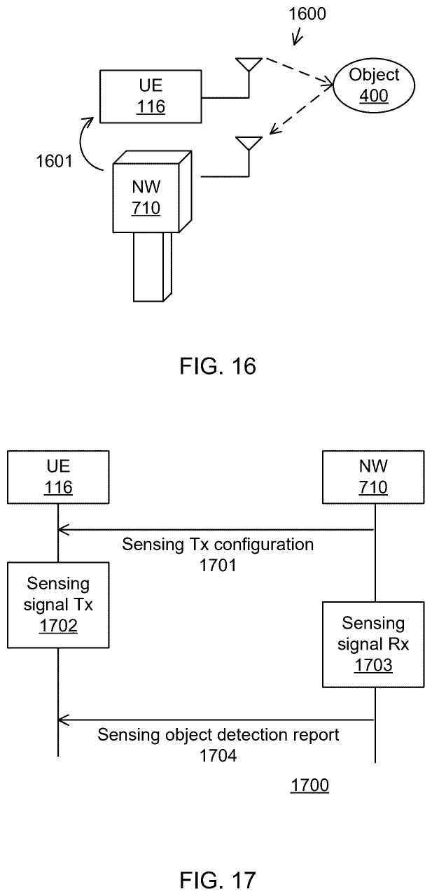

FIG. 16 illustrates an example diagram for NW-UE bistatic sensing, with the UE as transmitter, according to various embodiments of this disclosure. The embodiment of FIG. 16 is for illustration only. Other embodiments of the system 1600 could be used without departing from the scope of this disclosure.

In one embodiment of bistatic sensing, the network configures a UE to transmit sensing signals and the network receives sensing signal and performs object detection. FIG. 16 is an example 1600 illustrating network-UE bistatic sensing for the case when UE transmits sensing signal. NW 710 sends configuration information 1601 to UE 116. UE 116 transmits a sensing waveform in the direction of object 400, and NW 710 receives reflections of those waveforms off the object 400. Although the example is illustrated for one UE and one network node, there can be one or multiple UEs configured for sensing transmission, one or multiple network nodes configured for sensing reception, and potentially one or multiple other UEs also configured for sensing reception.

FIG. 17 illustrates a high level diagram of a signal flow for network-UE bistatic sensing, with the UE as transmitter, according to various embodiments of this disclosure. The embodiment of FIG. 17 is for illustration only. Other embodiments of the system 1700 could be used without departing from the scope of this disclosure. FIG. 17 may be performed within the system 1600 depicted in FIG. 16.

FIG. 17 is an example procedure for network-UE bistatic sensing involving one UE for sensing signal transmission. In step 1701, the network configures a UE with sensing transmission. Sensing transmission configuration can include sensing signal waveform, transmission power, transmission resource, timing, directional beam sweeping, etc., including but not limited to those described in TABLE 4. In step 1702, the UE transmits a sensing signal according to the configuration. In step 1703, the network receives reflections of sensing signal according to the configuration. After receiving the sensing signal, the network performs sensing object detection (not shown). A sensing object detection report 1704 may be sent to the UE, if the UE is the end consumer of the information. In another example, the network may send information regarding the received sensing signal instead of sensing object detection report.

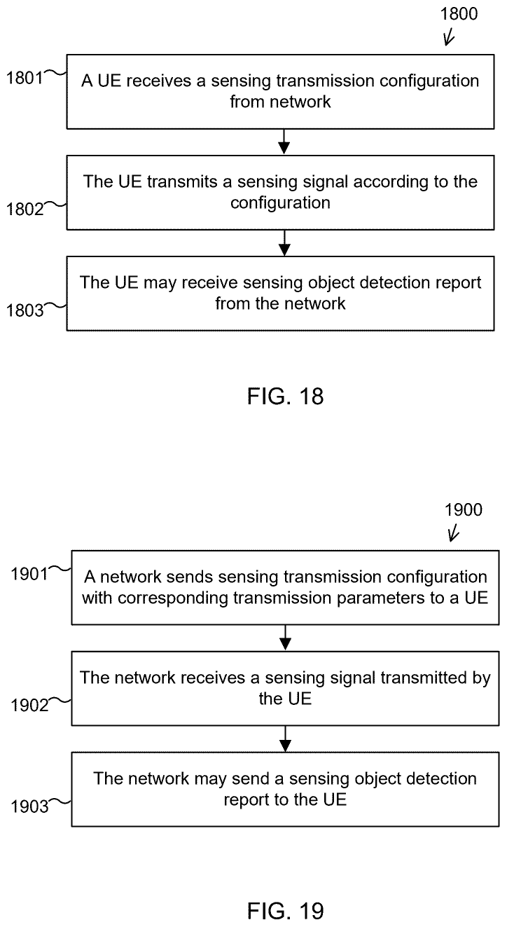

FIG. 18 illustrates a high level flowchart for UE operation in a network-UE bistatic sensing scenario, with the UE as transmitter, according to various embodiments of this disclosure. The embodiment of FIG. 18 is for illustration only. Other embodiments of the process 1800 could be used without departing from the scope of this disclosure.

FIG. 18 is an example of a method 1800 for network-UE bistatic sensing from a perspective of UE transmitting a sensing signal. In step 1801, a UE receives a sensing transmission configuration from the network. In step 1802, the UE transmits sensing signal(s) according to the configuration. In step 1803, the UE may receive a sensing object detection report from the network, depending upon the configuration.

FIG. 19 illustrates a high level flowchart for network operation in a network-UE bistatic sensing scenario, with the UE as transmitter, according to various embodiments of this disclosure. The embodiment of FIG. 19 is for illustration only. Other embodiments of the process 1900 could be used without departing from the scope of this disclosure.

FIG. 19 is an example of a method 1900 for network-UE bistatic sensing from the network perspective. In step 1901, a network sends sensing transmission configuration with corresponding transmission parameters to a UE. In step 1902, the network receives a sensing signal transmitted by the UE. In step 1903, the network may send a sensing object detection report to the UE.

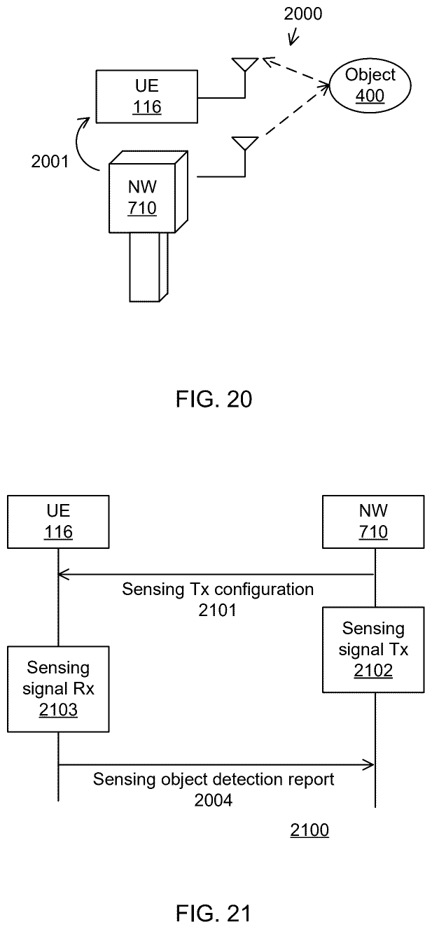

FIG. 20 illustrates an example diagram for NW-UE bistatic sensing, with the network as transmitter, according to various embodiments of this disclosure. The embodiment of FIG. 20 is for illustration only. Other embodiments of the system 2000 could be used without departing from the scope of this disclosure.

In one embodiment of bistatic sensing, the network configures a UE to receive sensing signals and the network transmits sensing signal. FIG. 20 is an example 2000 illustrating network-UE bistatic sensing for the case when UE receives sensing signal. NW 710 sends configuration information 2001 to UE 116. UE 116 transmits a sensing waveform in the direction of object 400, and NW 710 receives reflections of those waveforms off the object 400. Although the figure is illustrated for one UE and one network node, there can be one or multiple UEs configured for sensing reception, one or multiple network nodes configured for sensing transmission, and potentially one or multiple other UEs also configured for sensing transmission.

FIG. 21 illustrates a high level diagram of a signal flow for network-UE bistatic sensing, with the network as transmitter, according to various embodiments of this disclosure. The embodiment of FIG. 21 is for illustration only. Other embodiments of the system 2100 could be used without departing from the scope of this disclosure. FIG. 21 may be performed within the system 2000 depicted in FIG. 20.

FIG. 21 is an example procedure 2100 for network-UE bistatic sensing involving one UE for sensing signal reception. In step 2101, the network configures a UE with sensing reception. Sensing reception configuration can include target sensing signal waveform, resource, timing, and number of directional beams for reception, reporting format, etc., including but not limited to those described in TABLE 4. In step 2102, the network transmits sensing signal(s). In step 2103, the UE receives the sensing signal(s) according to the configuration. After receiving the sensing signal, the UE performs sensing object detection (not shown). A sensing object detection report 2004 may be sent to the network, if the network is the end consumer of the information. In another example, the UE may send information regarding the received sensing signal instead of sensing object detection report.

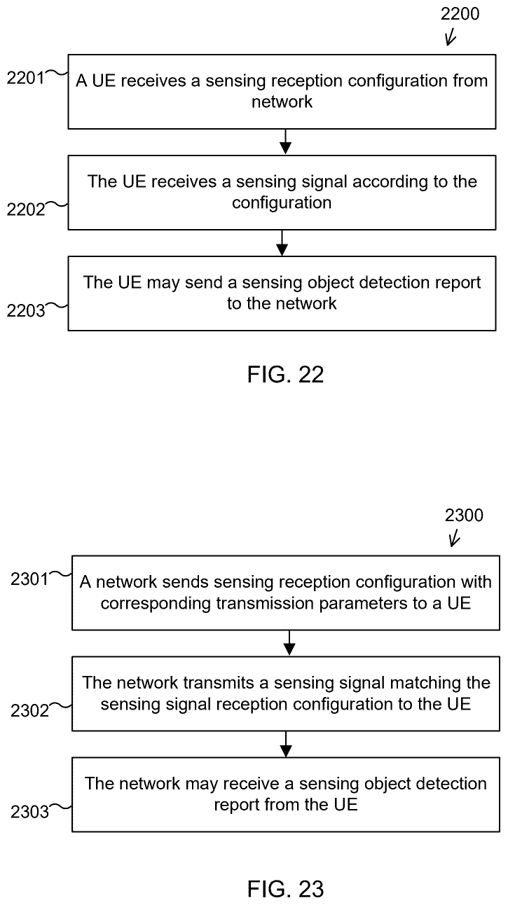

FIG. 22 illustrates a high level flowchart for UE operation in a network-UE bistatic sensing scenario, with the network as transmitter, according to various embodiments of this disclosure. The embodiment of FIG. 22 is for illustration only. Other embodiments of the process 2200 could be used without departing from the scope of this disclosure.

FIG. 22 is an example of a method 2200 for network-UE bistatic sensing from a perspective of UE receiving a sensing signal. In step 2201, a UE receives a sensing reception configuration from the network. In step 2202, the UE receives sensing signal(s) according to the configuration. In step 2203, the UE may send a sensing object detection report to the network, depending upon the configuration.

FIG. 23 illustrates a high level flowchart for network operation in a network-UE bistatic sensing scenario, with the network as transmitter, according to various embodiments of this disclosure. The embodiment of FIG. 23 is for illustration only. Other embodiments of the process 2300 could be used without departing from the scope of this disclosure.

FIG. 23 is an example of a method 2300 for network-UE bistatic sensing from the network perspective. In step 2301, A network sends sensing reception configuration with corresponding transmission parameters to a UE. In step 2302, the network transmits a sensing signal matching the sensing signal reception configuration to the UE. In step 2303, the network may receive a sensing object detection report from the UE.

Once the sensing signal is received, an object detection can be performed, e.g., by using a signal correlator or an energy detector. In one embodiment, the report message can be a one-bit indication if the signal correlator output or energy detector output is below or above a certain threshold. This threshold is configured by the NW. In another embodiment, the report can include a plurality of such indications if there are multiple multipath signals below or above the threshold. In yet another embodiment, the report can include information regarding the multipath profile such as delay spread, number of tabs, tab gain, and Doppler shift. In yet another embodiment, the report can indicate changes in the multipath profile. In yet another embodiment, the report can include angle of arrival (AoA) of the received signal, received signal gain per different AoA. Alternatively, in one embodiment, the object detection report message can include the detected object(s) profile itself such as type of the object, e.g., truck/passenger vehicle/motorcycle for automotive sensing, distance from the receiver to the object, direction related information, etc. If directional sensing is configured and the sensing signal is transmitted to different directions per beam sweeping, all the above disclosed report can be made per beam basis, i.e., along with the beam index indication.

In one embodiment, the report message can also include assistance information such as the UE location, speed, moving trajectory, etc. This information can be useful if the UE is in motion. The UE transmitting sensing signal can also send this assistance information to the NW.

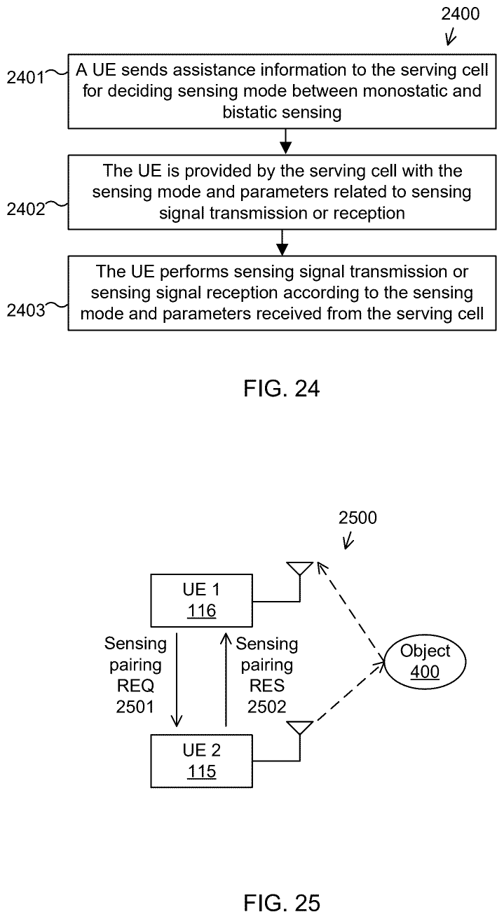

FIG. 24 illustrates a high level flowchart for UE operation regarding sensing mode decision according to various embodiments of this disclosure. The embodiment of FIG. 24 is for illustration only. Other embodiments of the process 2400 could be used without departing from the scope of this disclosure.

FIG. 24 illustrates an example procedure 2400 for a UE to provide assistance information regarding sensing mode determination to the serving cell and to receive the chosen sensing mode and related parameters from the serving cell.

At step 2401, a UE sends assistance information to the serving cell for deciding sensing mode between monostatic and bistatic sensing. The assistance information provided by the UE may include sensing application type, the UE location, and/or perceived channel environment, urban macro cell (Uma)/urban micro cell (Umi)/indoor hotspot (InH)/rural, clutter/blockage presence/density/severity, line of sight (LOS)/non line of sight (NLOS) indication, indoor/outdoor indication, in-car indication, in-building indication, mobility in terms of velocity or categorization of speeds, e.g., pedestrian/vehicle/high-speed train, etc. At step 2402, the UE is provided by the serving cell the sensing mode and parameters related to sensing signal transmission or reception. The UE may be indicated by the serving cell to perform monostatic sensing or bistatic sensing based on the assistance information provided by the UE to the serving cell. If the network indicated the UE to perform bistatic sensing, the network also provides whether the UE will assume the role of transmitter or receiver and related transmission or reception parameters. The determination by the serving cell on whether a UE to take the role of transmitter or receiver may depend on various factors. One example is the required sensing range for the requested sensing application. If the required sensing range goes beyond the coverage that a UE can cover with its transmission power, the serving cell may transmit the sensing radar signal with higher transmission power and the UE takes the role of receiver. As another example, the network may decide a UE to perform sensing transmission or reception based on the remaining battery level. As another example, the network may decide a UE to perform sensing transmission or reception based on round robin manner. As another example, the network may decide a UE to receive sensing signal if the UE is the consumer of the sensing object detection outcome to avoid the overhead of sending the object detection report to the UE. At step 2403, the UE performs sensing signal transmission or sensing signal reception according to the sensing mode and parameters received from the serving cell.

The present disclosure provides designs for the support of joint communication and radar sensing. In particular, this disclosure relates to a framework to support multi-device bistatic sensing in wireless communication systems.

Embodiments of the disclosure for supporting joint communication and radar sensing in wireless communication systems may be summarized as follows:
Method for bistatic sensing in D2D communication in which a UE initiating the bistatic sensing pairing is the sensing signal receiver and another UE responding to the bistatic sensing pairing request is the sensing signal transmitter.
Method for bistatic sensing in D2D communication in which a UE initiating the bistatic sensing pairing is the sensing signal transmitter and another UE responding to the bistatic sensing pairing request is the sensing signal receiver.

FIG. 25 illustrates an example diagram for D2D bistatic sensing, in the case when the initiating UE is the sensing signal receiver, according to various embodiments of this disclosure. The embodiment of FIG. 25 is for illustration only. Other embodiments of the system 2500 could be used without departing from the scope of this disclosure.

In one embodiment, UEs can be paired in a distributed manner via D2D communication for bistatic sensing without intervention from the network. FIG. 25 is an example illustration of bistatic sensing in D2D scenario, in which the initiating UE 1 116 that sends the sensing pairing request message 2501 is the sensing signal receiver and the UE 2 115 that responds 2502 to the sensing pairing request message is the sensing signal transmitter. UE 2 115 transmits a sensing waveform in the direction of object 400, and UE 1 116 receives reflections of those waveforms off the object 400. Although the figure is illustrated for two-UE scenario, there can be one or multiple UEs sending the sensing pairing request and one or multiple UEs responding to the sensing pairing request.

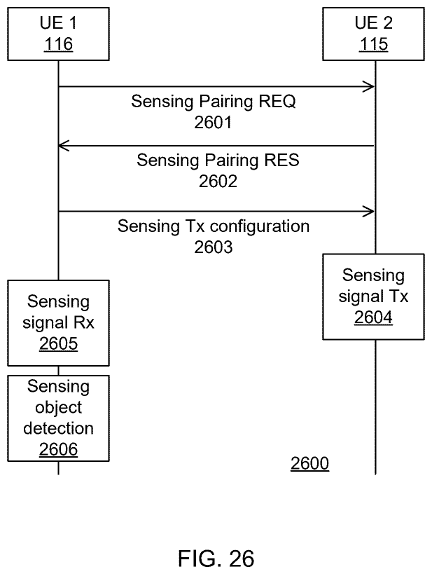

FIG. 26 illustrates a high level diagram of a signal flow for D2D bistatic sensing, in the case when the initiating UE is the sensing signal receiver, according to various embodiments of this disclosure. The embodiment of FIG. 26 is for illustration only. Other embodiments of the system 2600 could be used without departing from the scope of this disclosure. FIG. 26 may be performed within the system 2500 depicted in FIG. 25.

FIG. 26 is an example procedure 2600 for bistatic sensing in D2D scenario involving two UEs, in which the initiating UE is the sensing signal receiver. In step 2601, the first UE sends sensing pairing request message. The sensing paring request message can include but is not limited to IEs disclosed in TABLES 1-3. For example, the request message can include the initiating UE ID, the initiating UE's sensing capability related information as listed in TABLE 1, intended sensing operation related information as listed in TABLE 2, or an index of predefined sensing modes as exemplified in TABLE 3. The sensing pairing request message can also indicate the intended operation from a responding UE, e.g., to operate as sensing signal transmitter for bistatic sensing in this example. The sensing pairing request message can be included in a periodic beacon transmission for D2D link setup and maintenance or as a separate message. In step 2602, the second UE sends sensing pairing response message. The sensing paring response message can include but is not limited to IEs disclosed in TABLES 1-3. For example, the response message can include the responding UE ID, the responding UE's sensing capability related information as listed in TABLE 1, confirmation on the sensing operation related information as listed in TABLE 2, or the supported set of sensing modes as exemplified in TABLE 3. In step 2603, the first UE sends sensing transmission configuration to the second UE. The sensing transmission configuration message can include but not limited to IEs disclosed in TABLE 4. Although not shown in FIG. 26, the second UE can send a confirmation message upon the reception of sensing transmission configuration message. In step 2604, the second UE transmits sensing signal as configured in step 2603. In step 2605, the first UE receives sensing signal according to the sensing transmission configuration sent in step 2603. In step 2606, the first UE performs sensing object detection based on the received sensing signal in step 2605. A sensing object detection report may be sent to the NW, or to another UE, including the second UE, if the first UE is not the end consumer of the sensing information.

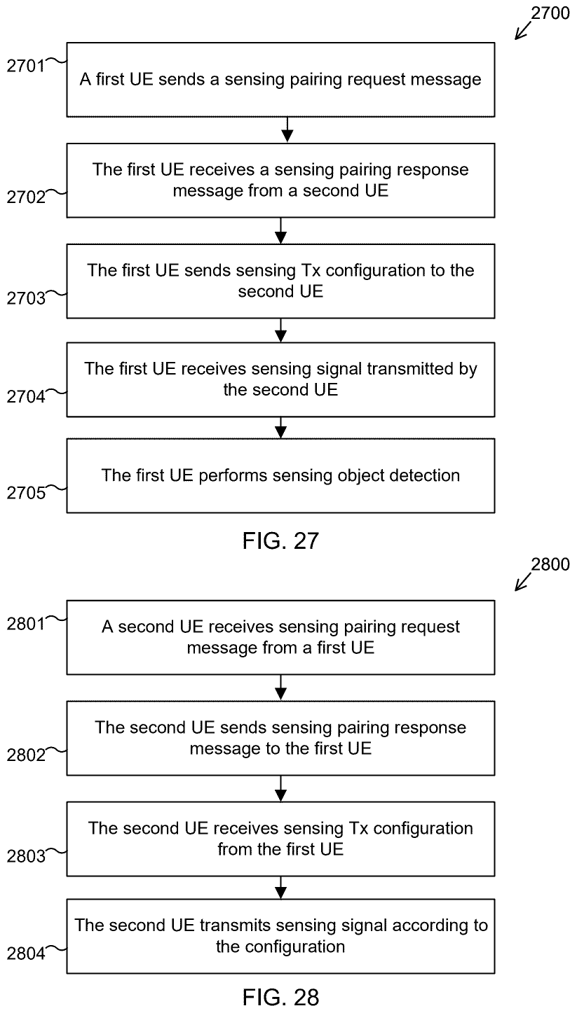

FIG. 27 illustrates a high level flowchart for UE operation of an initiating UE in a D2D bistatic sensing scenario according to various embodiments of this disclosure. The embodiment of FIG. 27 is for illustration only. Other embodiments of the process 2700 could be used without departing from the scope of this disclosure.

FIG. 27 is an example of a method 2700 for bistatic sensing in a D2D scenario from the perspective of an initiating UE. In step 2701, a first UE sends a sensing pairing request message. In step 2702, the first UE receives a sensing pairing response message from a second UE. In step 2703, the first UE sends sensing Tx configuration to the second UE. In step 2704, the first UE receives sensing signal transmitted by the second UE. In step 2705, the first UE performs sensing object detection.

FIG. 28 illustrates a high level flowchart for UE operation of a responding UE in a D2D bistatic sensing scenario according to various embodiments of this disclosure. The embodiment of FIG. 28 is for illustration only. Other embodiments of the process 2800 could be used without departing from the scope of this disclosure.

FIG. 28 is an example of a method 2800 for bistatic sensing in a D2D scenario from the perspective of a responding UE. In step 2801, a second UE receives a sensing pairing request message from a first UE. In step 2802, the second UE sends a sensing pairing response message to the first UE. In step 2803, the second UE receives a sensing Tx configuration from the first UE. In step 2804, the second UE transmits a sensing signal according to the configuration.

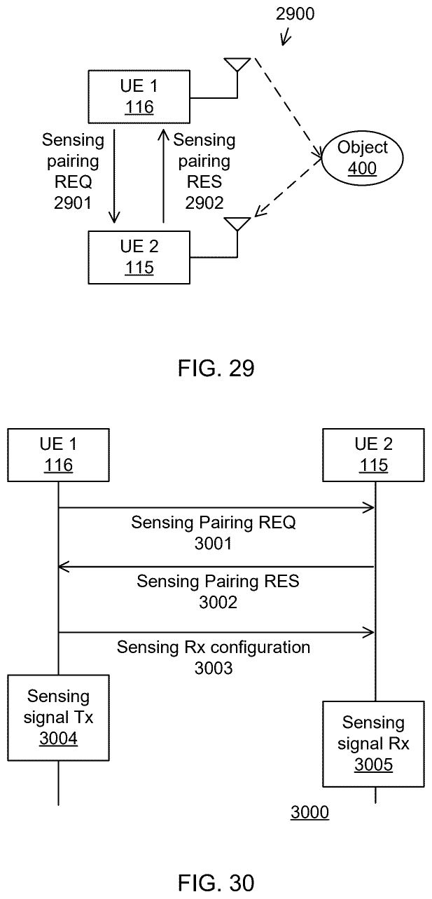

FIG. 29 illustrates an example diagram for D2D bistatic sensing, in the case when the initiating UE is the sensing signal transmitter, according to various embodiments of this disclosure. The embodiment of FIG. 29 is for illustration only. Other embodiments of the system 2900 could be used without departing from the scope of this disclosure.

In one embodiment, UEs can be paired in a distributed manner via D2D communication for bistatic sensing without intervention from the network. FIG. 29 is an example illustration of bistatic sensing in D2D scenario in which the initiating UE 1 116 that sends the sensing pairing request message 2901 is the sensing signal transmitter and the UE 2 115 that responds 2902 to the sensing pairing request message is the sensing signal receiver. UE 1 116 transmits a sensing waveform in the direction of object 400, and UE 2 115 receives reflections of those waveforms off the object 400. Although the figure is illustrated for two-UE scenario, there can be one or multiple UEs sending the sensing pairing request and one or multiple UEs responding to the sensing pairing request.

FIG. 30 illustrates a high level diagram of a signal flow for D2D bistatic sensing, in the case when the initiating UE is the sensing signal transmitter, according to various embodiments of this disclosure. The embodiment of FIG. 30 is for illustration only. Other embodiments of the system 3000 could be used without departing from the scope of this disclosure. FIG. 30 may be performed within the system 2900 depicted in FIG. 29.

FIG. 30 is an example procedure for bistatic sensing in D2D scenario involving two UEs in which the initiating UE is the sensing signal transmitter. In step 3001, the first UE sends sensing pairing request message. The sensing paring request message can include but is not limited to IEs disclosed in TABLES 1-3. For example, the request message can include the initiating UE ID, the initiating UE's sensing capability related information as listed in TABLE 1, intended sensing operation related information as listed in TABLE 2, or index of predefined sensing modes as exemplified in TABLE 3. The sensing pairing request message can also indicate the intended operation from a responding UE, e.g., to operate as sensing signal transmitter for bistatic sensing in this example. The sensing pairing request message can be included in a periodic beacon transmission for D2D link setup and maintenance or as a separate message. In step 3002, the second UE sends a sensing pairing response message. The sensing paring response message can include but is not limited to IEs disclosed in TABLES 1-3. For example, the response message can include the responding UE ID, the responding UE's sensing capability related information as listed in TABLE 1, confirmation on the sensing operation related information as listed in TABLE 2, or the supported set of sensing modes as exemplified in TABLE 3. In step 3003, the first UE sends sensing reception configuration to the second UE. The sensing reception configuration message can include but is not limited to IEs disclosed in TABLE 4. Although not shown, the second UE can send a confirmation message upon the reception of sensing reception configuration message. In step 3004, the first UE transmits a sensing signal in accordance with the sensing signal reception configuration sent in step 3003. In step 3005, the second UE receives sensing signal according to the sensing reception configuration sent in step 3003. In step 3006, the second UE performs sensing object detection based on the received sensing signal in step 3005 and may send the sensing object detection report to the first UE or to the NW. The sensing object detection report may not be sent if the second UE is the end consumer of the sensing information.

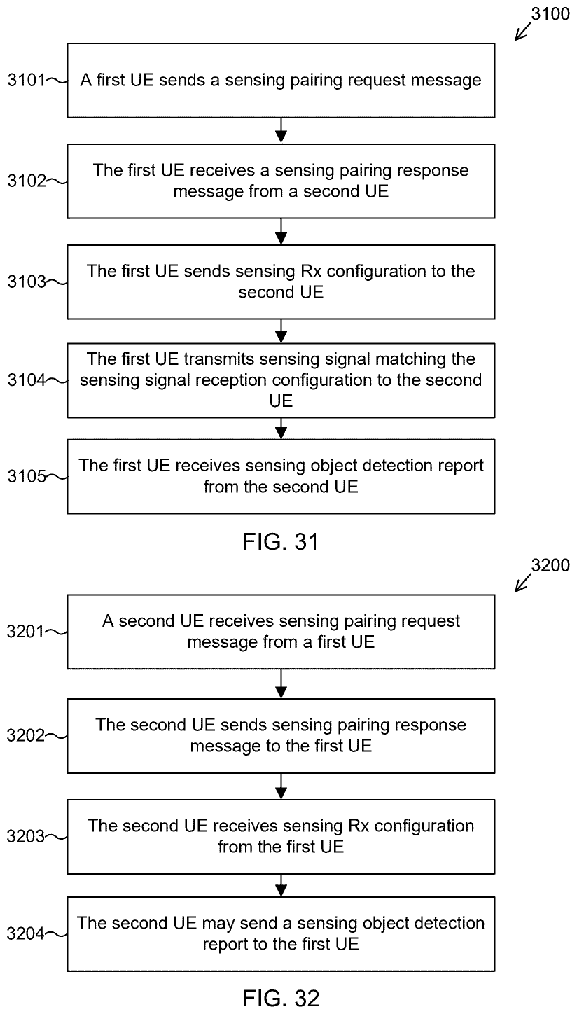

FIG. 31 illustrates a high level flowchart for UE operation of a responding UE in a D2D bistatic sensing scenario according to various embodiments of this disclosure. The embodiment of FIG. 31 is for illustration only. Other embodiments of the process 3100 could be used without departing from the scope of this disclosure.

FIG. 31 is an example of a method 3100 for bistatic sensing in a D2D scenario from the perspective of an initiating UE. In step 3101, a first UE sends a sensing pairing request message. In step 3102, the first UE receives a sensing pairing response message from a second UE. In step 3103, the first UE sends sensing Rx configuration to the second UE. In step 3104, the first UE transmits a sensing signal matching the sensing signal reception configuration to the second UE. In step 3105, the first UE receives a sensing object detection report from the second UE.

FIG. 32 illustrates a high level flowchart for UE operation of a responding UE in a D2D bistatic sensing scenario according to various embodiments of this disclosure. The embodiment of FIG. 32 is for illustration only. Other embodiments of the process 3200 could be used without departing from the scope of this disclosure.

FIG. 32 is an example of a method 3200 for bistatic sensing in a D2D scenario from the perspective of a responding UE. In step 3201, a second UE receives a sensing pairing request message from a first UE. In step 3202, the second UE sends a sensing pairing response message to the first UE. In step 3203, the second UE receives a sensing Rx configuration from the first UE. In step 3204, the second UE may send a sensing object detection report to the first UE.

For illustrative purposes the steps of algorithms above are described serially. However, some of these steps may be performed in parallel to each other. The operation diagrams illustrate example methods that can be implemented in accordance with the principles of the present disclosure and various changes could be made to the methods illustrated in the flowcharts. For example, while shown as a series of steps, various steps in each figure could overlap, occur in parallel, occur in a different order, or occur multiple times. In another example, steps may be omitted or replaced by other steps.

Although this disclosure has been described with an exemplary embodiment, various changes and modifications may be suggested to one skilled in the art. It is intended that this disclosure encompass such changes and modifications as fall within the scope of the appended claims.

What is claimed is:

1. A method for a user equipment (UE) to perform sensing, the method comprising:
transmitting information related to a sensing capability;
receiving information related to performing sensing, wherein the information related to performing sensing provides:
information related to a sensing report; and
one of:
one or more first parameters related to transmission of a first sensing signal, the one or more first parameters indicating at least:
a signal type of the first sensing signal,
one or more parameters related to transmission power control, and
a time or frequency resource for transmission of the first sensing signal, and
one or more second parameters related to reception of a second sensing signal, the one or more second parameters indicating at least:
a signal type of the second sensing signal, and
a time or frequency resource for reception of the second sensing signal;
one of:
determining a power for transmission of the first sensing signal and transmitting the first sensing signal based on (i) the one or more first parameters and (ii) the determined power; and
receiving the second sensing signal based on the one or more second parameters;
determining a sensing target (ST) and one or more characteristics related to the ST including (i) a location or a distance and (ii) a velocity; and
transmitting the sensing report based on the information related to the sensing report, wherein the sensing report indicates the ST and the one or more characteristics related to the ST.

2. The method of claim 1, wherein the one or more characteristics related to the ST include a horizontal or vertical direction to the ST from the UE.

3. The method of claim 1, wherein the one or more characteristics related to the ST include micro-Doppler information.

4. The method of claim 1, wherein:
the one or more first parameters further indicate a periodicity for transmission of the first sensing signal, and
the one or more second parameters further indicate a periodicity for reception of the second sensing signal.

5. The method of claim 1, wherein the information related to the sensing capability includes at least one of:
a maximum power for transmission of the first sensing signal,
a maximum bandwidth for transmission of the first sensing signal,
a maximum bandwidth for reception of the second sensing signal,
one or more supported frequency bands for sensing,
one or more supported sensing signal types, and
a support for separate antennas for communication and sensing.

6. The method of claim 1, wherein the one or more parameters related to transmission power control includes a maximum allowed power for transmission of the first sensing signal.

7. The method of claim 1, further comprising:
transmitting, to another UE, a pairing request for sensing, the pairing request including:
an identifier of the UE, and
information related to an intended sensing operation; and
receiving, from the other UE, a pairing response for sensing, the pairing response including:
an identifier of the other UE, and
information related to sensing capability supported by the other UE.

8. A user equipment (UE), comprising:
a processor; and
a transceiver operably coupled with the processor, the transceiver configured to:
transmit information related to a sensing capability; and
receive information related to performing sensing, wherein the information related to performing sensing provides:
information related to a sensing report; and
one of:
one or more first parameters related to transmission of a first sensing signal, the one or more first parameters indicating at least: a signal type of the first sensing signal, one or more parameters related to transmission power control, and a time or frequency resource for transmission of the first sensing signal, and
one or more second parameters related to reception of a second sensing signal, the one or more second parameters indicating at least: a signal type of the second sensing signal, and a time or frequency resource for reception of the second sensing signal;
wherein one of:
the processor is further configured to determine a power for transmission of the first sensing signal and the transceiver is further configured to transmit the first sensing signal based on (i) the one or more first parameters and (ii) the determined power; and
the transceiver is further configured to receive the second sensing signal based on the one or more second parameters;
wherein the processor is further configured to determine a sensing target (ST) and one or more characteristics related to the ST including (i) a location or a distance and (ii) a velocity; and
wherein the transceiver is further configured to transmit the sensing report based on the information related to the sensing report, wherein the sensing report indicates the ST and the one or more characteristics related to the ST.

9. The UE of claim 8, wherein the one or more characteristics related to the ST include a horizontal or vertical direction to the ST from the UE.

10. The UE of claim 8, wherein the one or more characteristics related to the ST include micro-Doppler information.

11. The UE of claim 8, wherein:
the one or more first parameters further indicate a periodicity for transmission of the first sensing signal, and
the one or more second parameters further indicate a periodicity for reception of the second sensing signal.

12. The UE of claim 8, wherein the information related to the sensing capability includes at least one of:
a maximum power for transmission of the first sensing signal,
a maximum bandwidth for transmission of the first sensing signal,
a maximum bandwidth for reception of the second sensing signal,
one or more supported frequency bands for sensing,
one or more supported sensing signal types, and
a support for separate antennas for communication and sensing.

13. The UE of claim 8, wherein the one or more parameters related to transmission power control includes a maximum allowed power for transmission of the first sensing signal.

14. The UE of claim 8, wherein the transceiver is further configured to:
transmit, to another UE, a pairing request for sensing, the pairing request including:
an identifier of the UE, and
information related to an intended sensing operation; and
receive, from the other UE, a pairing response for sensing, the pairing response including:
an identifier of the other UE, and
information related to sensing capability supported by the other UE.

15. A base station (BS), comprising:
a processor; and
a transceiver operably coupled with the processor, the transceiver configured to:
receive information related to a sensing capability; and
transmit information related to performing sensing, wherein the information related to performing sensing provides:
information related to a sensing report; and
one of:
one or more first parameters related to transmission of a first sensing signal, the one or more first parameters indicating at least: a signal type of the first sensing signal, one or more parameters related to transmission power control, and a time or frequency resource for transmission of the first sensing signal, and
one or more second parameters related to reception of a second sensing signal, the one or more second parameters indicating at least: a signal type of the second sensing signal, and a time or frequency resource for reception of the second sensing signal;
wherein one of:
the first sensing signal is transmitted based on (i) the one or more first parameters and (ii) a power determined for transmission of the first sensing signal, and
the second sensing signal is received based on the one or more second parameters,
wherein the transceiver is further configured to receive the sensing report based on the information related to the sensing report, and
wherein the sensing report indicates a sensing target (ST) and one or more characteristics related to the ST including (i) a location or a distance and (ii) a velocity.

16. The BS of claim 15, wherein the one or more characteristics related to the ST include a horizontal or vertical direction to the ST from the UE.

17. The BS of claim 15, wherein the one or more characteristics related to the ST include micro-Doppler information.

18. The BS of claim 15, wherein:
the one or more first parameters further indicate a periodicity for transmission of the first sensing signal, and
the one or more second parameters further indicate a periodicity for reception of the second sensing signal.

19. The BS of claim 15, wherein the information related to the sensing capability includes at least one of:
a maximum power for transmission of the first sensing signal,
a maximum bandwidth for transmission of the first sensing signal,
a maximum bandwidth for reception of the second sensing signal,
one or more supported frequency bands for sensing,
one or more supported sensing signal types, and
a support for separate antennas for communication and sensing.

20. The BS of claim 15, wherein the one or more parameters related to transmission power control includes a maximum allowed power for transmission of the first sensing signal.
